(19) United States
(12) Patent Application Publication
(10) Pub. No.: US 2022/0288453 A1
(43) Pub. Date: Sep. 15, 2022

(54) Golf Ball Locator Apparatus

(71) Applicants: John Ian PAGET, Warrington (GB); Lee DEAKIN, Warrington (GB)

(72) Inventors: John Ian PAGET, Warrington (GB); Lee DEAKIN, Warrington (GB)

(21) Appl. No.: 17/693,377

(22) Filed: Mar. 13, 2022

(30) Foreign Application Priority Data
Mar. 15, 2021 (GB) 2103519.1

(51) Int. Cl. A63B 24/00; A63B 43/06; A63B 53/04; G06K 7/10; G06K 19/077; G06K 19/07

(52) U.S. Cl. CPC A63B 24/0021; A63B 43/06; A63B 53/04; G06K 7/10386; G06K 19/0776; G06K 19/0723; A63B 2024/0034; A63B 2024/0053; A63B 2225/54

(57) ABSTRACT

The present invention relates to a golf ball locator apparatus comprising: a passive RFID tag comprising at least one attachment feature for releasable engagement to a golf ball; and an RFID reader comprising: at least one attachment feature for releasable engagement to a head of a golf club; an antenna configured to generate a high frequency electromagnetic field for detecting the passive RFID tag; a signal device operable to provide a signal to a user when the antenna has detected the golf ball; and a power source operable to provide power to the antenna and signal device.

This application claims priority from UK patent application GB2103519.1, the entirety of which is explicitly incorporated herein by reference.

### FIELD OF THE INVENTION

The present invention relates to apparatus for locating golf balls and a method for producing the apparatus.

### BACKGROUND

Golf balls are often lost during play and it can take a considerable amount of time trying to find lost golf balls. Often, golf balls are left behind without being found by the user.

There is therefore a need for an apparatus which would help to efficiently locate lost golf balls enabling the user to quickly return to playing golf.

### PRIOR ART

GB201820516 (JORDAN et al) discloses an intelligent electronic sticker for monitoring a dynamic state of a vehicle to detect a vehicle accident.

EP3619503 (FYFE et al) discloses a first location device.

US20150094167 (ZIMMERMAN) discloses a golf ball locating system.

US2005/0070375 (SAVARESE et al) discloses golf balls for use with a system for finding golf balls and methods for making such gold balls.

W02006/119563 (LOCBER PTY LTD) discloses a method, apparatus and computer program for locating objects.

US7207902 (HAMLIN) discloses an apparatus for locating a golf ball during play.

US2009/0017944 (SAVARESE et al) discloses an integrated GPS device and an RFID transceiver.

The present invention arose in order to overcome problems suffered by existing devices and systems.

### SUMMARY OF THE INVENTION

According to a first aspect of the present invention there is provided a golf ball locator apparatus comprising:

a passive RFID tag comprising at least one attachment feature for releasable engagement to a golf ball; and

an RFID reader comprising:

at least one attachment feature for releasable engagement to a head of a golf club;

an antenna configured to generate a high frequency electromagnetic field for detecting the passive RFID tag;

a signal device operable to provide a signal to a user when the antenna has detected the golf ball; and

a power source operable to provide power to the antenna and signal device.

A passive RFID tag is one which does not have its own power supply but is instead powered by incident electromagnetic energy transmitted from an RFID reader.

The golf ball locator apparatus may comprise a single attachment feature or a plurality of attachment features for securing the RFID reader to the head of a golf club. This assists the user to ‘sweep’ the attachment feature over a wider area in order to attempt to locate the golf ball.

Preferably, the golf ball locator apparatus comprises at least one magnet to demountably attaches the apparatus to a shaft of the golf club.

The RFID reader preferably comprises a housing comprising a lower face, and opposed upper face, and side portions extending therebetween. A cavity is preferably defined between the inner surfaces of the upper face, lower face and side portions.

The antenna and power source, and optionally a signal device, are preferably stored within the cavity. In one embodiment, the housing preferably seals the antenna and power source, and optionally a signal device, from an external environment thereby protecting these components against water ingress into the cavity.

The housing may be composed of any suitable material. Preferably, the housing is composed of plastic, for example ABS plastic thereby providing a light weight housing.

The housing may be shaped to conform to substantially corresponding to a head of a golf club.

In one embodiment, the antenna is positioned at or adjacent the lower face of the housing.

The at least one attachment feature is located at or adjacent a side portion of the housing.

The signal device preferably comprises one or more visible and/or audible signal devices.

In one embodiment, the RFID reader comprises at least one LED operable to provide a light signal on detection of the golf ball. For example, the RFID reader may comprise at least one LED located on or adjacent the upper face of the RFID reader ensuring that the LED(s) are in line of sight of the user during use.

The RFID reader may for example comprise a plurality of LEDs. For example, the RFID reader may comprise a first LED operable to indicate power level of the power source. The first LED may be operable to be illuminated when the power level of the power source is below a predetermined level to provide a visual indication to the user that the RFID reader requires charging.

The RFID reader may comprise a second LED operable to provide a visual indication to a user when the antenna is in use and is scanning for the passive RFID tag. The RFID reader may further comprise a third LED operable to indicate when the antenna has located the passive RFID tag within the vicinity of the RFID reader.

The plurality of LEDs may be of the same colour or of different colours depending on the particular requirements for the RFID reader.

The RFID reader may comprise at least one alarm operable to provide an audible noise on detection of the golf ball. The alarm may therefor provide an audible signal to the user that the RFID reader has located the passive RDIF tag within the vicinity of the reader.

The power source is preferably a battery, preferably a rechargeable battery, for example a lithium-polymer battery.

The RFID reader may further comprise a charging port, for example a USB charging port, in communication with the power source.

The passive RFID tag may have any size and shape suitable for being placed onto a golf ball. For example the RFID tag may be selected from, but not to be limited to, square, rectangular, oval, polygonal, triangular, circular or semi-circular in shape.

The passive RFID tag is preferably planar in shape to ensure that on application to a golf ball that the RFID tag cause minimal aerodynamic impact. The passive RFID tag preferably comprises an upper surface and an opposed lower surface. Preferably, the thickness of the locator (as measured between the upper and lower surface) is kept to a minimum in order to minimise any resultant aerodynamic impact.

The upper surface may comprise any suitable surface decoration for example logos, names, designs etc such that a user can recognise their golf ball on sight.

The lower surface preferably comprises an adhesive layer for adhesion to a surface of a golf ball. The adhesive layer may be continuous or may be discontinuous across the lower surface.

In use, when a user has misplaced a golf ball, for example in the rough, the user can secure the RFID reader to the head of the golf club. The user can then move the club in sweeping movements across the grass, in a similar manner to a metal detector, until the RFID reader provides a signal from the signal device providing an indication that the golf ball has been located.

Preferably, the range of the RFID reader (as measured between the distance of the antenna and the RFID locator) is up to 5 m. The apparatus can therefore be used to find a lost golf ball within a reasonable range with confidence.

According to a second aspect of the present invention, there is provided a method for producing a golf ball locator apparatus as herein described, wherein the method comprises:

obtaining a passive RFID tag comprising at least one attachment feature for releasable engagement to a golf ball;

producing an RFID reader by:

obtaining an antenna configured to generate a high frequency electromagnetic field for detecting the passive RFID tag;

placing the antenna in communication with a power source operable to provide power to the antenna and signal device;

placing at least one signal device in communication with the antenna and the power source, wherein the signal device is operable to provide a signal to a user when the antenna has detected the golf ball; and

providing at least one attachment feature for releasable engagement of the RFID reader to a head of a golf club.

According to a third aspect of the present invention, there is provided a method of operating the golf ball locator apparatus according to any preceding claim comprising the steps of:

releasably engaging the antenna to a golf club;

energising the antenna to generate a high frequency electromagnetic field; and

sweeping the antenna in a vicinity of a golf ball; and generating an alert upon detection of the passive RFID tag.

According to a further aspect of the present invention, there is provided a golf ball locator kit includes the golf ball locator apparatus as hereindescribed, at least one golf ball and at least one passive RFID tag.

According to a yet further aspect of the present invention, there is provided a method of tracking a golf ball using a golf ball locator as hereindescribed comprising the steps of:

adhering at least one passive RFID tag to a golf ball;

initiating an ‘in flight’ tracking system;

striking a golf ball with a golf club; and

energising the antenna to generate a high frequency electromagnetic field; sweeping the antenna in a vicinity of a golf ball; and generating an alert upon detection of the passive RFID tag.

An ‘in flight’ tracking system may include an optical imager which is provides input image data to a processor which derives an estimated location of where a golf ball lands so as to provide a user with a guide of where to search in order to retrieve a lost golf ball.

A preferred embodiment of the invention will now be described by way of example only and with reference to the Figures in which:

### BRIEF DESCRIPTION OF FIGURES

FIG. 1 shows a schematic illustration of a perspective front view from below of an RFID reader of the golf ball locator apparatus according to one embodiment of the present invention;

FIG. 2 shows a schematic illustration of a perspective rear view from above of the RFID reader of FIG. 1;

FIG. 3 shows a schematic illustration of an exploded view of the RFID reader of FIG. 1;

FIG. 4 shows a schematic illustration of a front view of a passive RFID tag according to one embodiment of the golf ball locator apparatus of the present invention attached to a golf ball;

FIG. 5 shows a schematic illustration of a side view of the passive RFID tag attached to the golf ball of FIG. 4; and

FIG. 6 shows a schematic illustration of an exploded view of the passive RFID tag and the golf ball of FIG. 4.

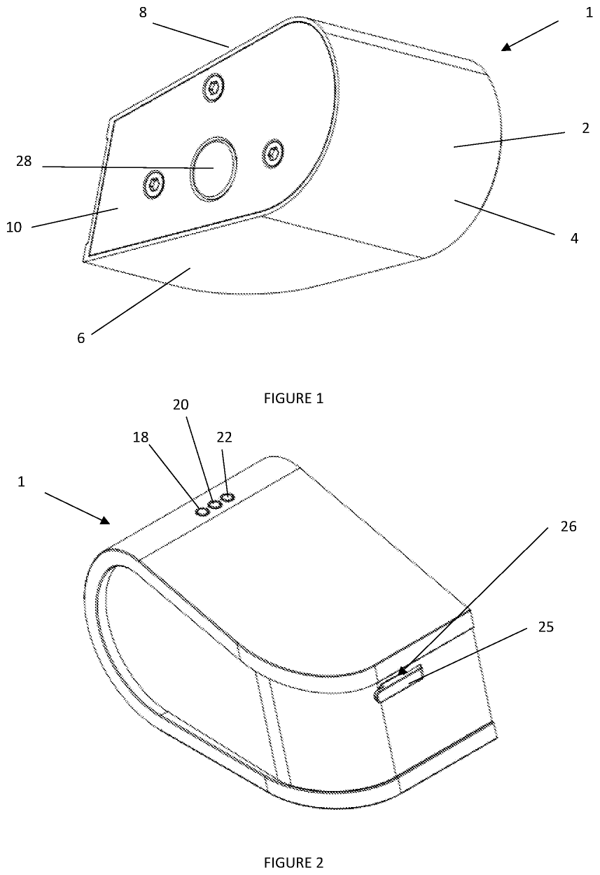

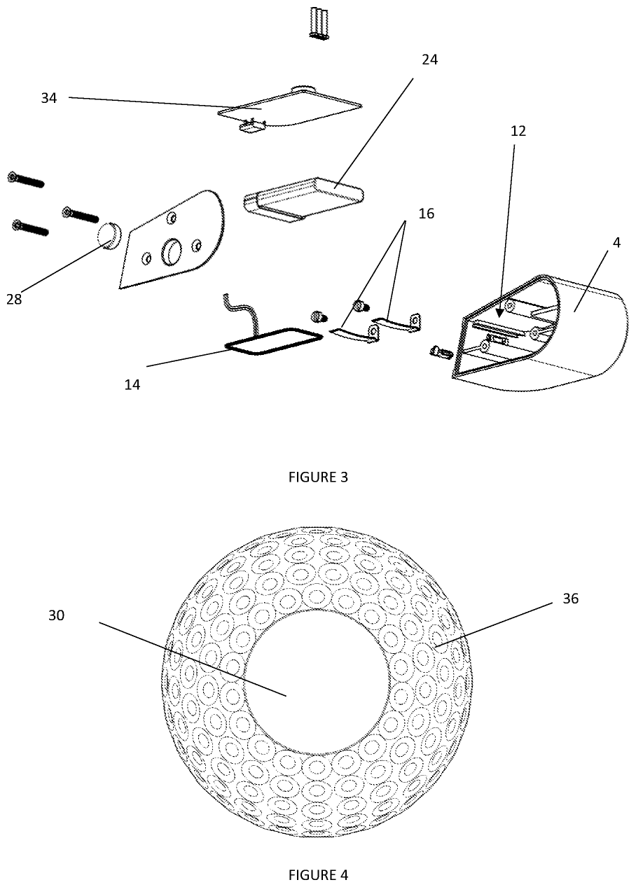

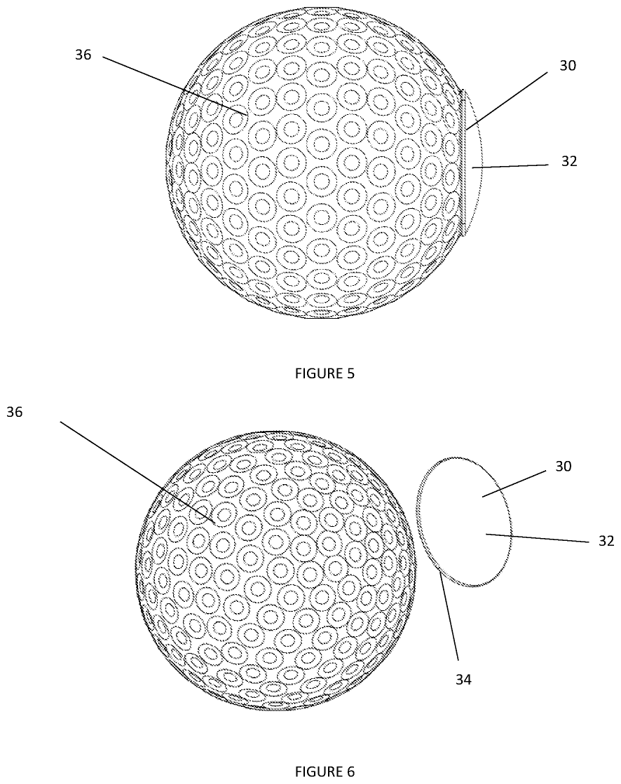

### DETAILED DESCRIPTION OF FIGURES

Referring to the Figures, a golf ball locator apparatus 1 comprises an RFID reader 2. The RFID reader 2 comprises a housing 4 comprising a lower face 6, and opposed upper face 8, and side portions 10 extending therebetween. A cavity 12 is defined between the inner surfaces of the upper face 8, lower face 10 and side portions 10. The housing 4 is composed of plastic, for example ABS plastic thereby providing a light weight housing. The housing 4 is shaped and profiled to largely correspond to a head of a golf club.

The RFID reader 2 further comprises an antenna 14 configured to generate a high frequency electromagnetic field.

The antenna 14 is located within the cavity 12 and positioned adjacent the lower face 6 of the housing 4. The antenna 14 is held in positioned by a pair of antenna braces 16, in the form of bent sheet metal, against the lower face 6 of the housing 4.

The RFID reader 2 further comprises three signal devices 18, 20, 22 operable to provide a signal to a user when the antenna 14 has detected the golf ball. The three signal devices 18. 20 and 22 are provided in the form of LEDs located on the upper face 8 of the housing 4. It is however to be understood that other signal devices may be used, for example audio signal devices or a combination of audio and light signal devices.

The first signal device 18 is a red coloured LED and operable to be illuminated when the power level of the power source 24 is below a predetermined level thereby providing a visual indication to the user that the RFID reader requires charging.

The second signal device 20 is a green coloured LED and operable to be illuminated when the RFID reader has detected a RFID tag in the nearby vicinity.

The third signal device 22 is a white coloured LED and operable to be illuminated when the RFID reader is in use to provide an indication to the user that the antenna is in operation.

The RFID reader 2 further comprises a power source 24 in the form of a battery operable to provide power to the antenna and signal device.

The power source 24 is located within the cavity 12 housing 4. The housing 4 further provides a charging port 26 in the form of a USB charging port in communication with the power source 24. The charging port may comprise a rubber plug 25 to prevent water and dirt ingress.

The housing 4 seals the antenna 14 and power source 24 from an external environment thereby protecting these components against water ingress into the cavity 12.

The RFID reader 2 further comprises a magnet 28 located on a side portion 10 of the housing 4. The magnet 28 being sized and shaped for attachment to a head of a golf club. Although the illustrated embodiment has a single magnet it is to be understood that the RFID reader may comprise any suitable number of magnets. It is also to be understood that the RFID reader may comprise any suitable number and types of attachment features and is not limited to the use of magnets.

The apparatus 1 further comprises a passive RFID tag 30 in the form of a planar circular tag having an upper surface 32 and an opposed lower surface 34. An adhesive layer is provided on the lower surface 34 of the tag for engaging the tag 30 to a golf ball 36.

In use, the user locates a passive RFID tag 30 and adheres the lower surface 34 to a golf ball.

Once the ball is lost within for example long grass, the user attaches the RFID reader 2 to the head of a golf club by securing the magnet 28 to the head.

The user then walks around the area that the golf ball is lost in and moves the golf club in a sweeping action similar to a metal detector. As the RFID reader 2 sweeps through the area, the antenna is sending out a high frequency electromagnetic field. Once the RFID reader 2 detects the presence of the tag 30 within an area, the second signal device 20 provides a clear visual indication that the tag 30 has been found.

The present invention therefore provides an efficient and easy apparatus for locating lost golf balls.

The passive RFID tag may have any size and shape suitable for being placed onto a golf ball. For example the RFID tag may be selected from, but not to be limited to, square, rectangular, oval, polygonal, triangular, circular or semi-circular in shape.

The passive RFID tag is preferably planar in shape to ensure that on application to a golf ball that the RFID tag cause minimal aerodynamic impact. The passive RFID tag preferably comprises an upper surface and an opposed lower surface.

Preferably, the thickness of the locator (as measured between the upper and lower surface) is kept to a minimum in order to minimise any resultant aerodynamic impact.

The upper surface may comprise any suitable surface decoration for example logos, names, designs etc such that a user can recognise their golf ball on sight.

The lower surface preferably comprises an adhesive layer for adhesion to a surface of a golf ball. The adhesive layer may be continuous or may be discontinuous across the lower surface.

The passive RFID tag may be provided on a sheet containing a plurality of passive RFID tags, for example a sheet comprising a plurality of adhesive RFID tags.

In use, when a user has misplaced a golf ball, for example in the rough, the user can secure the RFID reader to the head of the golf club. The user can then move the club in sweeping movements across the grass, in a similar manner to a metal detector, until the RFID reader provides a signal from the signal device providing an indication that the golf ball has been located.

Preferably, the range of the RFID reader (as measured between the distance of the antenna and the RFID locator) is up to 5 m. The apparatus can therefore be used to find a lost golf ball within a reasonable range with confidence. In another embodiment the apparatus can be modified to a live tracking device. This enables an imager or other tracking means to follow a golf ball, after having been struck by the golf club, to its end location.

The invention has been described by way of examples only and it will be appreciated that variation may be made to the above-mentioned embodiments without departing from the scope of protection as defined by the claims.

1. A golf ball locator apparatus comprising:
a passive RFID tag comprising at least one attachment feature for releasable engagement with a golf ball; and
an RFID reader comprising:
at least one attachment feature for releasable engagement to a head of a golf club;
an antenna which is operative to transmit a high frequency electromagnetic field for detecting the passive RFID tag;
a signal device operable to provide a signal to a user when the antenna has detected the golf ball; and
a power source operable to provide power to the antenna and the signal device.

2. A golf ball locator apparatus as claimed in claim 1, wherein the at least one attachment feature comprises at least one magnet.

3. A golf ball locator apparatus as claimed in claim 1, wherein the RFID reader comprises a housing with a lower face, an opposed upper face, and side portions extending therebetween, wherein the antenna is positioned at the lower face of the housing.

4. A golf ball locator apparatus as claimed in claim 3, wherein the at least one attachment feature is located at the side portion of the housing.

5. A golf ball locator apparatus as claimed in claim 3, wherein the housing is formed from a synthetic plastics material.

6. A golf ball locator apparatus as claimed in claim 3 wherein the antenna and power source are sealed within the housing.

7. A golf ball locator apparatus as claimed in claim 1, wherein the signal device comprises at least one visible signalling device.

8. A golf ball locator apparatus as claimed in claim 1, wherein the signal device comprises at least one audible signalling device.

9. A golf ball locator apparatus as claimed in claim 7, wherein the at least one visible signalling device is at least one LED operable to provide a light signal on detection of the golf ball.

10. A golf ball locator apparatus as claimed in claim 1, wherein the RFID reader comprises at least one alarm operable to provide an audible noise on detection of the golf ball.

11. A golf ball locator apparatus as claimed in claim 1, wherein the power source is a battery.

12. A golf ball locator apparatus as claimed in claim 1, wherein the RFID reader includes a charging port for charging a rechargeable battery.

13. A golf ball locator apparatus as claimed in claim 1, wherein the passive RFID tag has an adhesive layer for adhering the tag to the golf ball.

14. A method of operating the golf ball locator apparatus according to any prcccding claim 1 comprising the steps of:
releasably engaging the antenna to a golf club;
energising the antenna to generate a high frequency electromagnetic field; and
sweeping the antenna in a vicinity of a golf ball; and
generating an alert upon detection of the passive RFID tag.

15. A golf ball locator kit includes the apparatus according to claim 1 further comprising, at least one golf ball and at least one passive RFID tag.

16. A method of tracking a golf ball using a golf ball locator according to claim 14 further comprising the steps of:
adhering at least one passive RFID tag to a golf ball;
initiating an ‘in flight’ tracking system;
striking a golf ball with a golf club;
energising the antenna to generate a high frequency electromagnetic field;
sweeping the antenna in a vicinity of a golf ball; and
generating an alert upon detection of the passive RFID tag.
